(19) United States
(12) Patent Application Publication
(10) Pub. No.: US 2025/0166951 A1
(43) Pub. Date: May 22, 2025

(54) ELECTROMAGNETIC RELAY

(71) Applicant: OMRON Corporation, Kyoto-shi, Kyoto (JP)

(72) Inventors: Ayata HORIE, Kyoto-shi, Kyoto (JP); Hiroyuki IWASAKA, Kyoto-shi, Kyoto (JP); Ryota MINOWA, Kyoto-shi, Kyoto (JP); Shinichi OGAWA, Kyoto-shi, Kyoto (JP); Kohei OTSUKA, Kyoto-shi, Kyoto (JP)

(21) Appl. No.: 18/696,367

(22) PCT Filed: Sep. 16, 2022
(86) PCT No.: PCT/JP2022/034677

§ 371 Date: Nov. 8, 2024

(30) Foreign Application Priority Data
Oct. 20, 2021 (JP) 2021-171776

(51) Int. Cl. H01H 50/54

(52) U.S. Cl. CPC H01H 50/54

(57) ABSTRACT

An electromagnetic relay includes a first fixed terminal, a first fixed contact, a second fixed terminal, a second fixed contact, a movable contact piece, a first movable contact, a second movable contact, a contact spring, and a moving member. The movable contact piece includes a through hole positioned centrally in a first direction. The moving member is movable in a second direction. The moving member passes through the through hole and is coupled to the movable contact piece at the center of the movable contact piece in the first direction to be relatively movable. The moving member has a clearance relative to the through hole of the movable contact piece, so that, when at least one of the second fixed contact and the second movable contact is lost, the clearance allows the movable contact piece to be tilted with respect to the moving member by the urging force of the contact spring and directly or indirectly contact the second fixed terminal.

### CROSS-REFERENCE TO RELATED APPLICATION

This application is the U.S. National Phase of International Application No. PCT/JP2022/034677, filed on Sep. 16, 2022. That application claims priority to Japanese Patent Application No. 2021-171776, filed Oct. 20, 2021. The contents of those two applications are incorporated by reference herein in their entireties.

### FIELD

The claimed invention relates to an electromagnetic relay.

### BACKGROUND

Conventionally, electromagnetic relays for opening and closing electric circuits have been known. The electromagnetic relay described in Japanese Patent Application Publication No. 2017-079109 is a plunger-type electromagnetic relay and includes a pair of contact sections including a pair of fixed contacts and a pair of movable contacts, a movable contact piece, a drive shaft, and a contact spring. The pair of movable contacts is connected to the movable contact piece. The drive shaft passes through a through-hole in the movable contact piece and is coupled to the movable contact piece so as to be movable relative to the movable contact piece. The contact spring urges the movable contact piece in a direction in which the pair of movable contacts approaches the pair of fixed contacts.

In an electromagnetic relay, when a large current such as a short-circuit current flows through a pair of contact sections, sometimes one of the contact sections melts and at least one of the fixed contact and the movable contact is lost (i.e., disappears). In this case, in order to maintain contact between the melted contact sections, a configuration can be provided where the movable contact piece is tilted by the urging force of a contact spring.

However, in the electromagnetic relay of Japanese Patent Application Publication No. 2017-079109, the gap between the through-hole of the movable contact piece and the drive shaft is small, and thereby there is a risk that the movable contact piece and the drive shaft may interfere with each other and the contact between the contact sections cannot be maintained. In addition, in order to maintain the contact of the melted contact section by tilting the drive shaft together with the movable contact piece, an increased urging force of the contact spring is required.

### SUMMARY

An object of the claimed invention is to provide an electromagnetic relay in which the urging force of a contact spring can be efficiently transmitted to a movable contact piece when at least one of a fixed contact and a movable contact melts.

An electromagnetic relay according to one aspect of the claimed invention includes a first fixed terminal, a first fixed contact, a second fixed terminal, a second fixed contact, a movable contact piece, a first movable contact, and a second movable contact, a contact spring, and a moving member. The first fixed contact is connected to the first fixed terminal. The second fixed terminal is disposed apart from the first fixed terminal in a first direction. The second fixed contact is connected to the second fixed terminal. The movable contact piece includes a through-hole positioned centrally in the first direction. The first movable contact is connected to the movable contact piece and faces the first fixed contact in a second direction. The second direction includes a contact direction in which the first movable contact approaches the first fixed contact and a separation direction in which the first movable contact moves away from the first fixed contact. The second movable contact is connected to the movable contact piece and faces the second fixed contact in the second direction. The contact spring configured to urge the movable contact piece in the contact direction. The moving member is movable in the second direction. The moving member passes through the through-hole and is coupled to the movable contact piece at the center of the movable contact piece in the first direction so as to be movable relative to the movable contact piece. The moving member has a clearance relative to the through-hole of the movable contact piece so that when at least one of the second fixed contact and the second movable contact is lost, the clearance allows the movable contact piece to be tilted with respect to the moving member by the urging force of the contact spring so as to directly or indirectly contact the second fixed terminal.

In the electromagnetic relay, when at least one of the fixed contact and the movable contact melts and the movable contact piece is tilted with respect to the moving member, the clearance between the through-hole of the movable contact piece and the moving member functions to reduce the interference between the movable contact piece and the moving member. As a result, an electromagnetic relay can be provided in which the urging force of the contact spring can be efficiently transmitted to the movable contact piece when at least one of the fixed contact and the movable contact melts. Furthermore, since the urging force of the contact spring can be efficiently transmitted to the movable contact piece, the urging force of the contact spring required can be set small.

The clearance around the moving member may be defined such that the through-hole of the movable contact piece and the moving member do not interfere with each other when at least one of the second fixed contact and the second movable contact is lost and the movable contact piece, which is tilted with respect to the moving member, directly or indirectly contacts the second fixed terminal. In this case, the urging force of the contact spring required can be further decreased.

The moving member may be a shaft member extending parallel to the second direction and passing through the through-hole. The clearance around the moving member may be defined such that the moving member is maintained parallel to the second direction when at least one of the second fixed contact and the second movable contact is lost and the movable contact piece, which is tilted with respect to the moving member, directly or indirectly contacts the second fixed terminal. In this case, the urging force of the contact spring required can be further decreased.

Part of the clearance around the moving member may be configured by a groove formed on an outer peripheral surface of the moving member. In this case, the clearance can be easily prepared by a groove formed on the moving member.

The through-hole of the movable contact piece may have a tapered shape so that the clearance relative to the moving member increases as the through-hole extends in the contact direction. In this case, when at least one of the second fixed contact and the second movable contact is lost, the movable contact piece easily gets tilted with respect to the moving member by the urging force of the contact spring.

The through-hole of the movable contact piece may include a first edge in the contact direction. The first edge may have an R-chamfered shape or a C-chamfered shape. In this case, interference between the first edge and the through-hole can be reduced when at least one of the second fixed contact and the second movable contact disappears. With the configuration, even if the contact position of the contact is shifted, the movable contact piece easily gets tilted with respect to the moving member by the urging force of the contact spring.

The through-hole of the movable contact piece may include a second edge in the separation direction. The second edge may have an R-chamfered shape or a C-chamfered shape. In this case, interference between the second edge and the through-hole can be reduced when at least one of the second fixed contact and the second movable contact is lost. With the configuration, even if the contact position of the contact is shifted, the movable contact piece easily gets tilted with respect to the moving member by the urging force of the contact spring.

The through-hole of the movable contact piece may have an elliptical shape that is elongated in the first direction when viewed from the second direction. In this case, when at least one of the second fixed contact and the second movable contact is lost, the movable contact piece easily gets tilted with respect to the moving member by the urging force of the contact spring.

The through-hole of the movable contact piece may have a rectangular shape that is long in the first direction when viewed from the second direction. In this case, when at least one of the second fixed contact and the second movable contact is lost, the movable contact piece easily gets tilted with respect to the moving member by the urging force of the contact spring.

The first fixed terminal may include a first contact support section configured to support the first fixed contact. The second fixed terminal may include a second contact support section configured to support the second fixed contact. The first contact support section and the second contact support section may extend parallel to the movable contact piece. In this case, the terminal structure configured for decreasing the electromagnetic repulsion generated between the contacts is more likely to cause an event where the second fixed contact and the second movable contact melt, as compared to a terminal structure that is unable to decrease the electromagnetic repulsion: therefore, the significance of the claimed invention increases.

### BRIEF DESCRIPTION OF THE DRAWINGS

FIG. 1 is a schematic cross-sectional view of an electromagnetic relay in accordance with the claimed invention when the electromagnetic relay is in an open state.

FIG. 2 is a schematic cross-sectional view of the electromagnetic relay when the electromagnetic relay is in a closed state.

FIG. 3 is a schematic cross-sectional view of a movable contact piece and surrounding portions when the electromagnetic relay is in a closed state.

FIG. 4 is a diagram showing a state in which a movable contact piece is in direct contact with a second fixed terminal.

FIG. 5 is a sectional diagram showing a state in which a movable contact piece is in indirect contact with a second fixed terminal via a second fixed contact.

FIG. 6 is a sectional diagram illustrating a modification of a through-hole of a movable contact piece.

FIG. 7 is a sectional diagram illustrating a modification of a through-hole of a movable contact piece.

FIG. 8 is a sectional diagram illustrating a modification of a through-hole of a movable contact piece.

FIG. 9 is a schematic diagram of a movable contact piece, seen from above, according to a modification.

FIG. 10 is a schematic diagram of a movable contact piece, seen from above, according to a modification.

FIG. 11 is a diagram illustrating a modification of a drive shaft.

FIG. 12 is a diagram illustrating a modification of a moving member.

### DETAILED DESCRIPTION

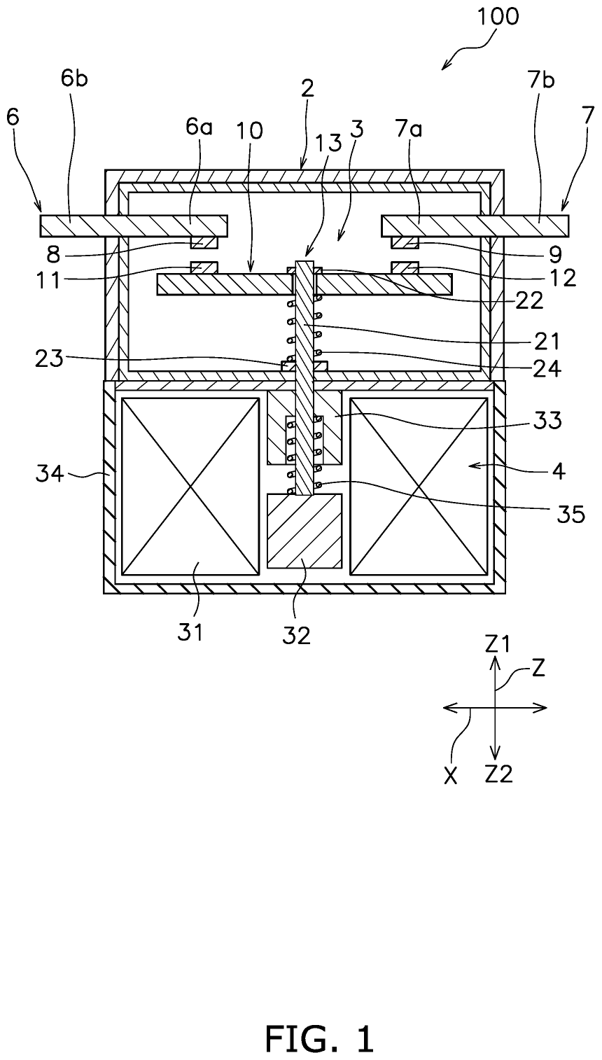

Hereinafter, one embodiment of an electromagnetic relay 100 according to one aspect of the claimed invention will be described with reference to the drawings. When referring to the drawings, for easier understanding of the description, the upper side in FIG. 1 will be referred to as “upper”, the lower side as “lower”, the left side as “left”, and the right side as “right”. Specifically, in FIG. 1, the direction indicated by arrow Z will be described as an up-down direction, the direction indicated by arrow Z1 as an upward direction, the direction indicated by an arrow Z2 as a downward direction, and the direction indicated by an arrow X as a left-right direction. Further, the direction perpendicular to the paper surface of FIG. 1 will be described as the front-rear direction. These directions are defined for convenience of description, and do not limit the directions in which the electromagnetic relay 100 is arranged. Note that the left-right direction in the present embodiment is an example of a first direction, and the up-down direction in the present embodiment is an example of a second direction.

FIG. 1 is a schematic cross-sectional view of the electromagnetic relay 100. As shown in FIG. 1, the electromagnetic relay 100 includes a case 2, a contact device 3, and a drive device 4.

The case 2 has a substantially rectangular box shape and is comprised of insulating material.

The contact device 3 is housed in the case 2. The contact device 3 includes a first fixed terminal 6, a second fixed terminal 7, a first fixed contact 8, a second fixed contact 9, a movable contact piece 10, a first movable contact 11, a second movable contact 12, and a movable mechanism 13.

The first fixed terminal 6 and the second fixed terminal 7 are plate terminals and extend in the left-right direction. The first fixed terminal 6 and the second fixed terminal 7 extend through the inside and outside of the case 2. The first fixed terminal 6 and the second fixed terminal 7 are comprised of conductive material such as copper.

The first fixed terminal 6 includes a first contact support section 6a and a first external connection section 6b. The first contact support section 6a is disposed inside the case 2. The first contact support section 6a extends parallel to the movable contact piece 10. The first external connection section 6b protrudes to the left from the case 2 and is exposed to the outside of the case 2.

The second fixed terminal 7 is arranged apart from the first fixed terminal 6 in the left-right direction. The second fixed terminal 7 is arranged to the right of the first fixed terminal 6. The second fixed terminal 7 includes a second contact support section 7a and a second external connection section 7b. The second contact support section 7a is disposed inside the case 2. The second contact support section 7a extends parallel to the movable contact piece 10. The second external connection section 7b protrudes from the case 2 to the right and is exposed to the outside of the case 2.

The first fixed contact 8 is comprised of conductive material such as copper. The first fixed contact 8 is connected to the first fixed terminal 6. The first fixed contact 8 is supported by the first contact support section 6a. The first fixed contact 8 protrudes downward from a lower surface of the first contact support section 6a.

The second fixed contact 9 is comprised of conductive material such as copper. The second fixed contact 9 is connected to the second fixed terminal 7. The second fixed contact 9 is supported by the second contact support section 7a. The second fixed contact 9 projects downward from a lower surface of the second contact support section 7a.

The movable contact piece 10 is a plate member that is long in one direction, and extends in the left-right direction inside the case 2. In the present embodiment, the longitudinal direction of the movable contact piece 10 coincides with the left-right direction. The lateral direction of the movable contact piece 10 coincides with the front-rear direction. The movable contact piece 10 is comprised of conductive material such as copper.

The movable contact piece 10 is arranged to be movable in a contact direction Z1 (here, for example, upward) in which the second movable contact 12 approaches the second fixed contact 9 as the first movable contact 11 approaches the first fixed contact 8, and in separation direction Z2 (here, for example, downward) in which the second movable contact 12 separates from the second fixed contact 9 as the first movable contact 11 separates from the first fixed contact 8. That is, in the present embodiment, the movable contact piece 10 is arranged so as to be movable in the up-down direction.

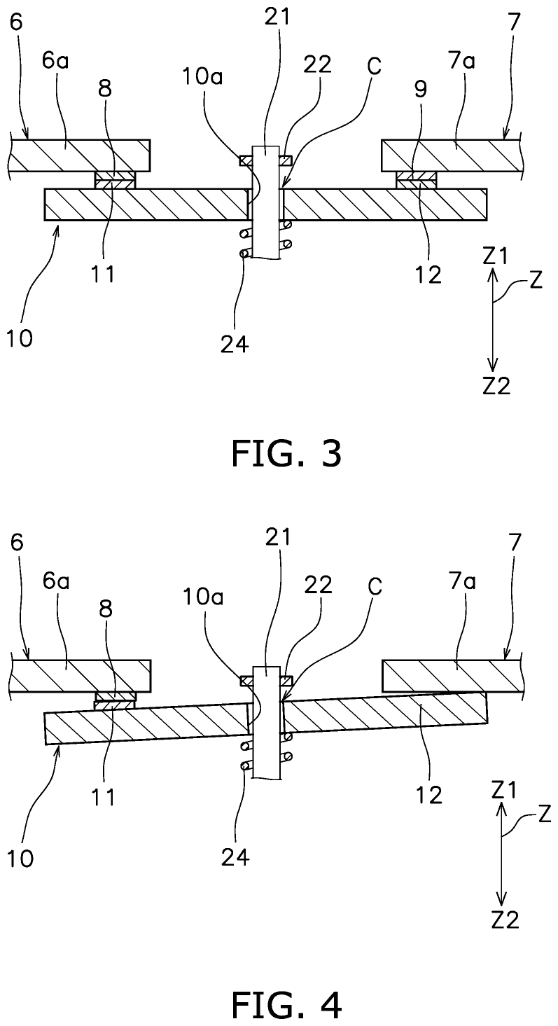

As shown in FIG. 3, the movable contact piece 10 has a through-hole 10a. The through-hole 10a is located at the center of the movable contact piece 10 in the left-right direction. The through-hole 10a is located at the center of the movable contact piece 10 in the front-rear direction. The through-hole 10a has a hole shape penetrating in the up-down direction. The through-hole 10a is circular when viewed in the up-down direction.

The first movable contact 11 is connected to the movable contact piece 10. The first movable contact 11 faces the first fixed contact 8 in the up-down direction. The first movable contact 11 is arranged below the first fixed contact 8. The first movable contact 11 projects upward from an upper surface of the movable contact piece 10. The first movable contact 11 is configured to contact the first fixed contact 8 in accordance with the movement of the movable contact piece 10. The first movable contact 11 is comprised of conductive material such as copper.

The second movable contact 12 is connected to the movable contact piece 10. The second movable contact 12 faces the second fixed contact 9 in the up-down direction. The second movable contact 12 is arranged below the second fixed contact 9. The second movable contact 12 projects upward from an upper surface of the movable contact piece 10. The second movable contact 12 is configured to contact the second fixed contact 9 in accordance with the movement of the movable contact piece 10. The second movable contact 12 is comprised of conductive material such as copper.

The movable mechanism 13 supports the movable contact piece 10. The movable mechanism 13 includes a drive shaft 21, a first holding member 22, a second holding member 23, and a contact spring 24.

The drive shaft 21 is an example of a moving member. The drive shaft 21 is a shaft member passing through the through-hole 10a of the movable contact piece 10 in the up-down direction. The drive shaft 21 extends parallel to the up-down direction. The drive shaft 21 is set to be movable in the up-down direction. The drive shaft 21 is connected to the movable contact piece 10 so as to be relatively movable at the center of the movable contact piece 10 in the left-right direction and the front-back direction.

The first holding member 22 is fixed to the drive shaft 21 above the movable contact piece 10. The second holding member 23 is fixed to the drive shaft 21 below the movable contact piece 10. The contact spring 24 is arranged in a compressed state between the movable contact piece 10 and the second holding member 23. The contact spring 24 is a coil spring, and the drive shaft 21 is arranged therein. The contact spring 24 urges the movable contact piece 10 in the contact direction Z1.

The drive device 4 is arranged below the contact device 3. The drive device 4 moves the movable contact piece 10 via the drive shaft 21 of the movable mechanism 13 by electromagnetic force. The drive device 4 includes a coil 31, a movable iron core 32, a fixed iron core 33, a yoke 34, and a return spring 35.

When excited by application of a voltage, the coil 31 generates an electromagnetic force which moves the movable iron core 32 in the contact direction Z1. The movable iron core 32 is connected to the drive shaft 21 so as to be integrally movable. The fixed iron core 33 is arranged at a position facing the movable iron core 32. The yoke 34 is arranged to surround the coil 31. The return spring 35 is arranged between the movable iron core 32 and the fixed iron core 33. The return spring 35 urges the movable iron core 32 in the separation direction Z2.

FIG. 1 shows a state in which the drive device 4 is not excited. While the drive device 4 is not excited, the first movable contact 11 is separated from the first fixed contact 8, and the second movable contact 12 is separated from the second fixed contact 9.

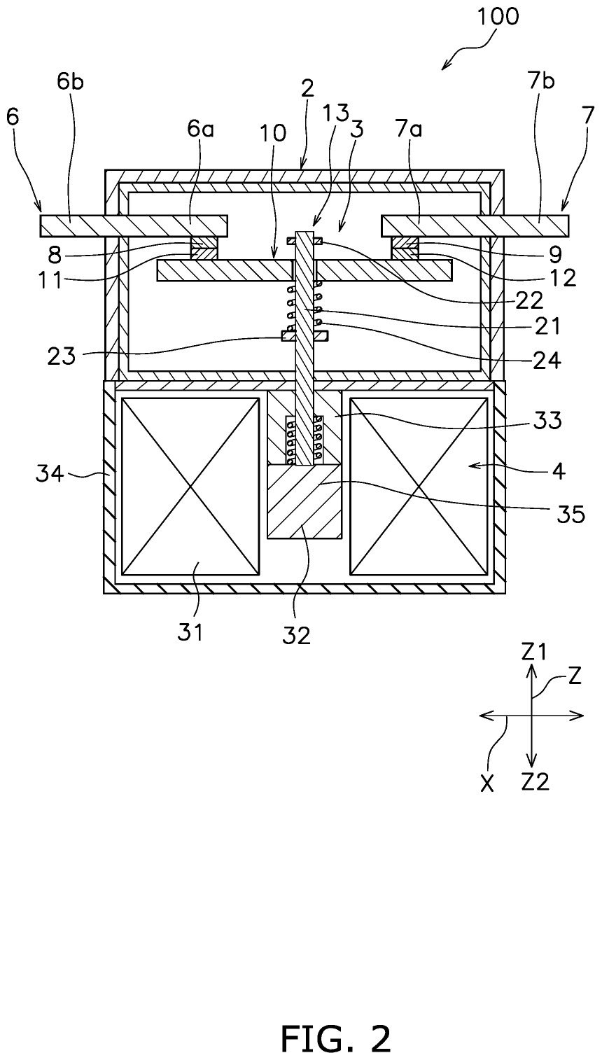

FIG. 2 shows the state when the drive device 4 is excited and the movable mechanism 13 has moved in the contact direction Z1. When the drive device 4 is excited, the movable iron core 32 moves together with the drive shaft 21 in the contact direction Z1. As the drive shaft 21 moves in the contact direction Z1, the contact spring 24 is compressed by the second holding member 23. As a result, the force pressing the movable contact piece 10 in the contact direction Z1 increases, the movable contact piece 10 moves in the contact direction Z1, the first movable contact 11 contacts the first fixed contact 8, and the second movable contact 12 contacts second fixed contact 9. In this state, the first holding member 22 is separated from the movable contact piece 10 in the up-down direction. Note that, in the states shown in FIGS. 1 and 2, the movable contact piece 10 is maintained in a horizontal state with respect to the drive shaft 21.

As shown in FIGS. 3 and 4, the drive shaft 21 has a clearance C relative to the through-hole 10a of the movable contact piece 10 so that when at least one of the second fixed contact 9 and the second movable contact 12 is lost, the clearance C allows the movable contact piece 10 to be tilted with respect to the drive shaft 21 by the urging force of the contact spring 24 so as to directly or indirectly contact the second fixed terminal 7. The clearance C is a clearance located between the drive shaft 21 and the through-hole 10a of the movable contact piece 10 in the left-right direction. That is, the clearance C allows the movable contact piece 10 to rotate clockwise and counterclockwise with respect to the drive shaft 21 when viewed from the front-rear direction.

The clearance C is defined such that the through-hole 10a of the movable contact piece 10 and the drive shaft 21 do not interfere with each other in the left-right direction when at least one of the second fixed contact 9 and the second movable contact 12 is lost and the movable contact piece 10, which is tilted with respect to the drive shaft 21, is in direct or indirect contact with the second fixed terminal 7.

The clearance C is defined such that the drive shaft 21 is maintained parallel to the up-down direction when at least one of the second fixed contact 9 and the second movable contact 12 is lost and the movable contact piece 10, which is tilted with respect to the drive shaft 21, is in direct or indirect contact with the second fixed terminal 7.

In the present embodiment, as shown in FIG. 4, the clearance C is defined such that in a state where both the second fixed contact 9 and the second movable contact 12 are lost and the movable contact piece 10 is tilted with respect to the drive shaft 21 by the urging force of the contact spring 24, the movable contact piece 10 directly contacts with the second fixed terminal 7. In the state shown in FIG. 4, the through-hole 10a of the movable contact piece 10 and the drive shaft 21 do not interfere with each other in the left-right direction, and the movable contact piece 10 is tilted with respect to the drive shaft 21 when viewed from the front-rear directions, and the drive shaft 21 is maintained parallel to the up-down direction.

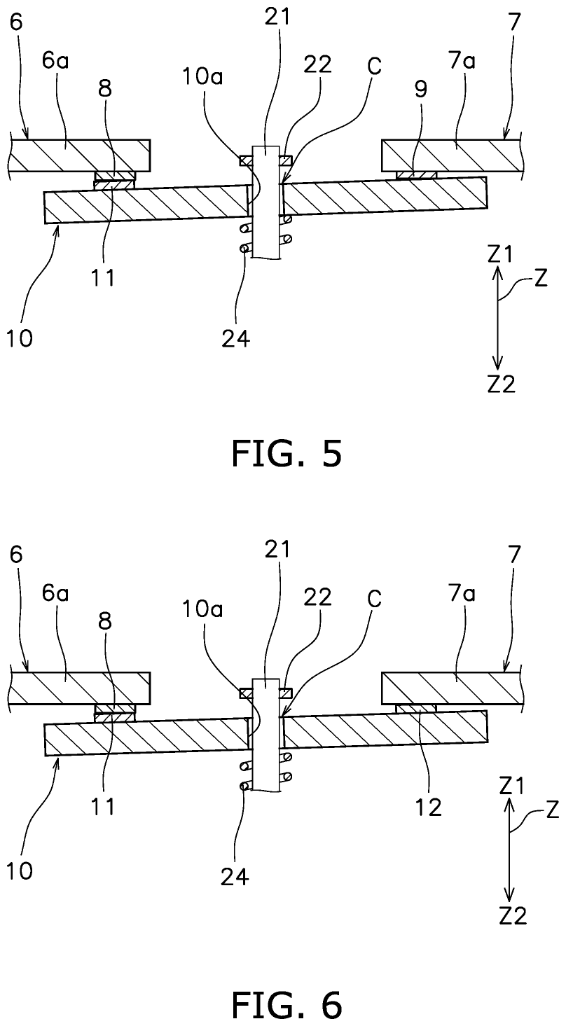

FIG. 5 shows a state in which the second movable contact 12 is lost and the movable contact piece 10 is tilted with respect to the drive shaft 21 and is indirect contact with the second fixed terminal 7 via the second fixed contact 9. FIG. 6 shows a state in which the second fixed contact 9 is lost and the movable contact piece 10 is tilted with respect to the drive shaft 21 and is indirect contact with the second fixed terminal 7 via the second movable contact 12.

In the electromagnetic relay 100 of the above configuration, when at least one of the second fixed contact 9 and the second movable contact 12 melts and the movable contact piece 10 is tilted with respect to the drive shaft 21, the clearance C between the through-hole 10a of the movable contact piece 10 and the drive shaft 21 work together to reduce the interference between the movable contact piece 10 and the drive shaft 21. With the configuration, when at least one of the second fixed contact 9 and the second movable contact 12 melts, the urging force by the contact spring 24 can be efficiently transmitted to the movable contact piece 10. Furthermore, since the urging force of the contact spring 24 can be efficiently transmitted to the movable contact piece 10, the urging force of the contact spring 24 required can be set small.

One embodiment of the electromagnetic relay according to one aspect of the claimed invention has been described above. The claimed invention, however, is not limited to the above embodiment, and various changes can be made without departing from the scope of the claimed invention.

In the above embodiment, the second fixed terminal 7 is arranged to the right of the first fixed terminal 6. The second fixed terminal 7, however, may be arranged to the left of the first fixed terminal 6. That is, the arrangement of the first fixed terminal 6 and the second fixed terminal 7, the arrangement of the first fixed contact 8 and the second fixed contact 9, and the arrangement of the first movable contact 11 and the second movable contact 12 may be exchanged.

The second fixed contact 9 and the second movable contact 12 may be comprised of different materials from each other. Furthermore, in the above embodiment, the first movable contact 11 and the second movable contact 12 may be embedded in the movable contact piece 10. That is, the first movable contact 11 and the second movable contact 12 do not need to protrude upward from the movable contact piece 10. When the first movable contact 11 and the second movable contact 12 protrude upward from the movable contact piece 10, the first fixed contact 8 may be embedded in the first fixed terminal 6, and the second fixed contact 9 may be embedded in the second fixed terminal 7. The tip surfaces of the first fixed contact 8, the second fixed contact 9, the first movable contact 11, and the second movable contact 12 may be arcuate in their cross-sectional view.

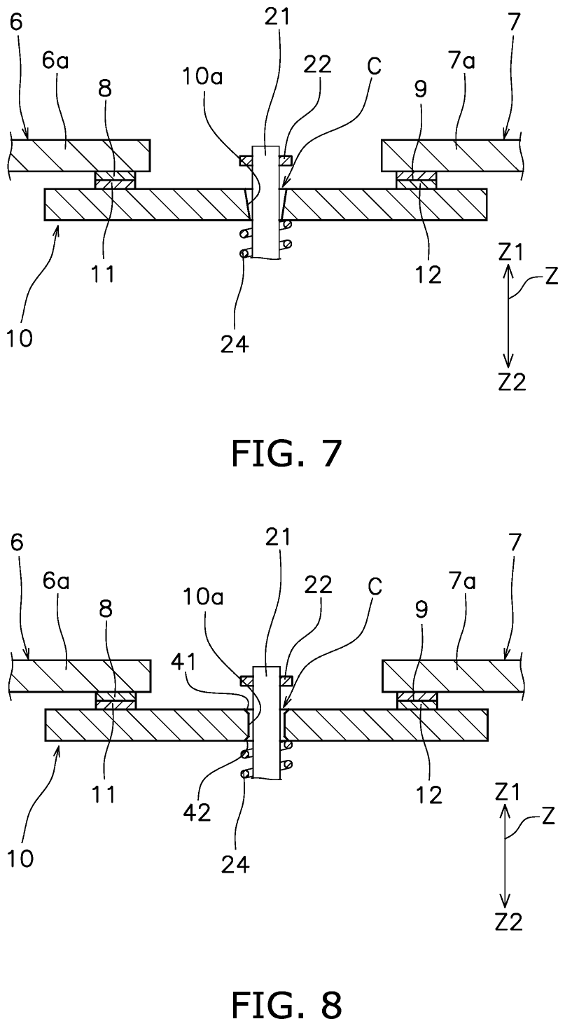

The shape of the through-hole 10a of the movable contact piece 10 may be changed. As shown in FIG. 7, the through-hole 10a may have a tapered shape in which the clearance C between the through-hole 10a and the drive shaft 21 increases as extending along the contact direction Z1.

As shown in FIG. 8, the through-hole 10a may include a first edge 41 extending in the contact direction Z1 and having an R-chamfered shape or a C-chamfered shape. In addition, the through-hole 10a may include the second edge 42 extending in the separation direction Z2 and having an R-chamfered shape or a C-chamfered shape.

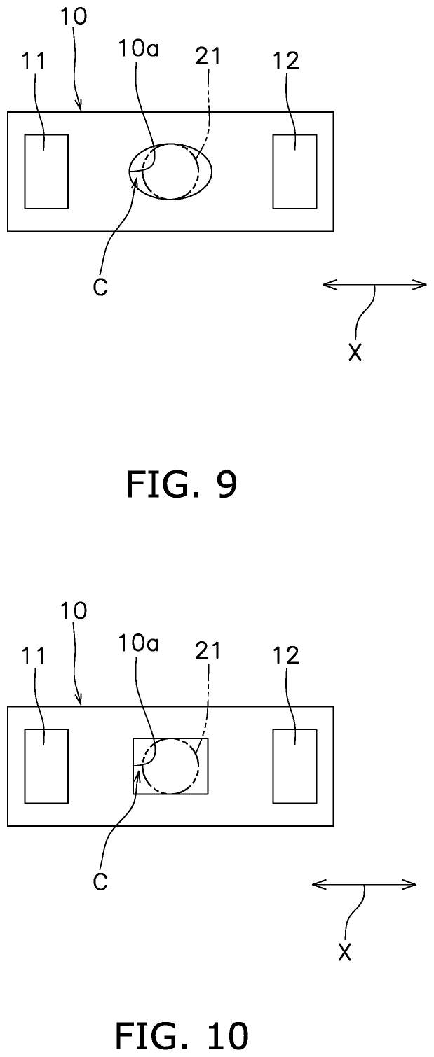

As shown in FIG. 9, the through-hole 10a may have an elliptical shape that is elongated in the left-right direction when viewed in the up-down direction. Alternatively, as shown in FIG. 10, the through-hole 10a may have a rectangular shape that is long in the left-right direction when viewed in the up-down direction. Note that, as shown in FIGS. 9 and 10, the clearance between the drive shaft 21 and the through-hole 10a of the movable contact piece 10 in the front-rear direction is preferably smaller than the clearance C.

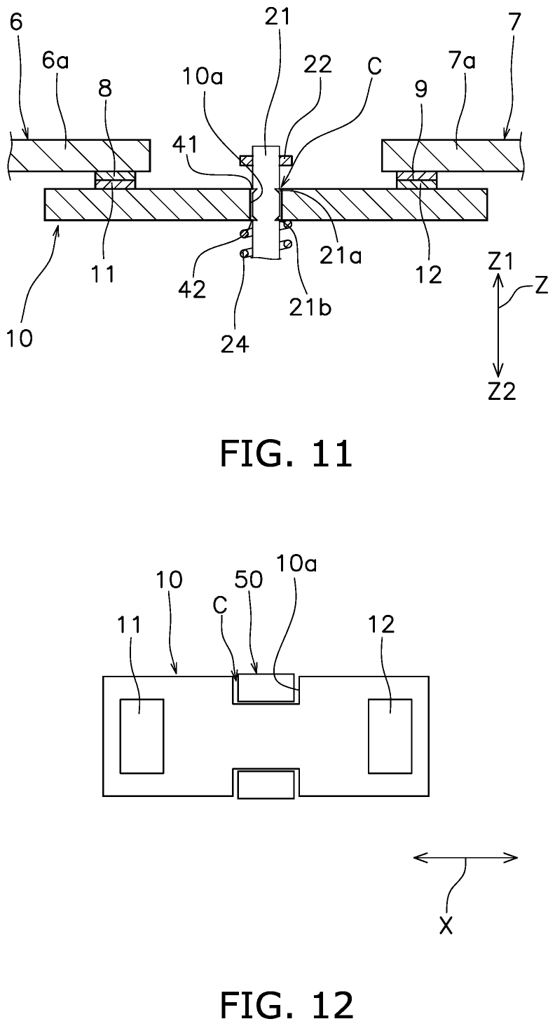

As shown in FIG. 11, part of the clearance C may be configured by grooves 21a and 21b formed on the outer peripheral surface of the drive shaft 21. The grooves 21a and 21b reduce the interference between the through-hole 10a of the movable contact piece 10 and the drive shaft 21 when at least one of the second fixed contact 9 and the second movable contact 12 is lost and the movable contact piece 10, which is tilted with respect to the drive shaft 21, directly or indirectly connects to the second fixed terminal 7.

The groove 21a is recessed toward the axis of the drive shaft 21. The groove 21a is located at a position that is close to the first edge 41 of the through-hole 10a when the first movable contact 11 is in contact with the first fixed contact 8 and the second movable contact 12 is in contact with the second fixed contact 9. The groove 21a inclines such that the clearance C increases as it extends in the contact direction Z1 when viewed from the front-rear direction. The groove 21b is located at a position that is close to the second edge 42 of the through-hole 10a when the first movable contact 11 is in contact with the first fixed contact 8 and the second movable contact 12 is in contact with the second fixed contact 9. The groove 21b inclines such that the clearance C increases as it extends in the separation direction Z2.

Note that the clearance C may be configured by appropriately combining the shapes of the through-hole 10a and the groove 21a described in FIGS. 7 to 11.

In the above embodiment, the drive shaft 21 is illustrated as an example of the moving member. The moving member, however, may be a holder 50 for holding the movable contact piece 10. In this case, the through-hole 10a is formed at both ends of the movable contact piece 10 in the front-rear direction at the center of the movable contact piece 10 in the longitudinal direction. The holder 50 is arranged to hold the movable contact piece 10 in the front-rear directions. The holder 50 passes through the through-hole 10a and is coupled to the movable contact piece 10 so as to be relatively movable. The contact spring 24 is arranged between the holder 50 and the movable contact piece 10.

The configurations of the contact device 3 and the drive device 4 may be changed. For example, a configuration is possible in which the movable contact piece 10 is arranged above the first fixed terminal 6 and the second fixed terminal 7 and the fixed iron core 33 is arranged below the movable iron core 32.

### REFERENCE NUMERALS

6: First fixed terminal, 7: Second fixed terminal, 8: First fixed contact, 9: Second fixed contact, 10: Movable contact piece, 10a: Through-hole, 11: First movable contact, 12: Second Movable contact, 21: Drive shaft (Example of moving member), 24: Contact spring, 41: First edge, 42: Second edge, 100: Electromagnetic relay, C: Clearance

1. An electromagnetic relay, comprising:
a first fixed terminal;
a first fixed contact connected to the first fixed terminal;
a second fixed terminal disposed apart from the first fixed terminal in a first direction;
a second fixed contact connected to the second fixed terminal;
a movable contact piece including a through-hole positioned centrally in the first direction;
a first movable contact connected to the movable contact piece, the first movable contact facing the first fixed contact in a second direction, the second direction including a contact direction in which the first movable contact approaches the first fixed contact and a separation direction in which the first movable contact moves away from the first fixed contact;
a second movable contact connected to the movable contact piece, the second movable contact facing the second fixed contact in the second direction;
a contact spring configured to urge the movable contact piece in the contact direction; and
a moving member movable in the second direction, the moving member passing through the through-hole, the moving member coupled to the movable contact piece at the center of the movable contact piece in the first direction so as to be movable relative to the movable contact piece, wherein
the moving member has a clearance relative to the through-hole of the movable contact piece so that when at least one of the second fixed contact and the second movable contact is lost, the clearance allows the movable contact piece to be tilted with respect to the moving member by urging force of the contact spring so as to directly or indirectly contact the second fixed terminal.

2. The electromagnetic relay according to claim 1, wherein the clearance around the moving member is defined such that the through-hole of the movable contact piece and the moving member do not interfere with each other when at least one of the second fixed contact and the second movable contact is lost and the movable contact piece, which is tilted with respect to the moving member, directly or indirectly contacts the second fixed terminal.

3. The electromagnetic relay according to claim 1, wherein the clearance around the moving member is defined such that the moving member is maintained parallel to the second direction when at least one of the second fixed contact and the second movable contact is lost and the movable contact piece, which is tilted with respect to the moving member, directly or indirectly contacts the second fixed terminal.

4. The electromagnetic relay according to claim 1, wherein part of the clearance around the moving member is configured by a groove formed on an outer peripheral surface of the moving member.

5. The electromagnetic relay according to claim 1, wherein the through-hole of the movable contact piece has a tapered shape so that the clearance relative to the moving member increases as the through-hole extends in the contact direction.

6. The electromagnetic relay according to claim 1, wherein
the through hole through-hole of the movable contact piece includes a first edge in the contact direction, and
the first edge has an R-chamfered shape or C-chamfered shape.

7. The electromagnetic relay according to claim 1, wherein
the through-hole of the movable contact piece includes a second edge in the separation direction, and
the second edge has an R-chamfered shape or a C-chamfered shape.

8. The electromagnetic relay according to claim 1, wherein the through-hole of the movable contact piece has an elliptical shape that is elongated in the first direction when viewed from the second direction.

9. The electromagnetic relay according to claim 1, wherein the through-hole of the movable contact piece has a rectangular shape that is long in the first direction when viewed from the second direction.

10. The electromagnetic relay according to claim 1, wherein
the first fixed terminal includes a first contact support section configured to support the first fixed contact,
the second fixed terminal includes a second contact support section configured to support the second fixed contact, and
the first contact support section and the second contact support section extend parallel to the movable contact piece.
